(19) United States
(12) Patent Application Publication
(10) Pub. No.: US 2014/0049229 A1
(43) Pub. Date: Feb. 20, 2014

(54) POWER GENERATION UNIT DRIVER, POWER GENERATION UNIT AND ENERGY OUTPUT EQUIPMENT IN POWER GRID

(71) Applicants: Jing Li, Beijing (CN); Hua Liao, Beijing (CN); Xin Hua Liu, Shangai (CN); Jing Wei Zhang, Beijing (CN)

(72) Inventors: Jing Li, Beijing (CN); Hua Liao, Beijing (CN); Xin Hua Liu, Shangai (CN); Jing Wei Zhang, Beijing (CN)

(73) Assignee: SIEMENS AKTIENGESELLSCHAFT, MUENCHEN (DE)

(21) Appl. No.: 14/004,469

(22) PCT Filed: Mar. 9, 2012
(86) PCT No.: PCT/EP2012/054128

§ 371 Date: Oct. 11, 2013

(30) Foreign Application Priority Data
Mar. 11, 2011 (CN) 201110059905.2
Mar. 11, 2011 (CN) 201120064590.6

(51) Int. Cl. H02P 11/06

(52) U.S. Cl. CPC H02P 11/06
USPC 322/39

(57) ABSTRACT

A power generation unit driver, a power generation unit and energy output equipment in a power grid are described. The power generation unit driver includes a drive controller for generating a drive signal according to a first control signal and a second control signal obtained thereby, a converter for transforming the input energy from a first voltage into a second voltage according to the drive signal and outputting the same to an electric motor connected to the power generation unit driver. The first control signal runs condition information of the electric motor, and the second control signal includes the power grid frequency and/or the voltage amplitude of the power grid. The concept produces improved effects on the stability of power supply by a power grid.

### TECHNICAL FIELD

The present invention relates to an electrical power system and, particularly, to a power generation unit driver, a power generation unit and energy output equipment in a power grid.

### BACKGROUND ART

Currently, a microgrid can refer to a small-scale power generation, distribution and utility system composed of one or more portions of a distributed power generation unit, an energy converting device, a monitoring device, a protective device and related loads. In this case, the so-called “small-scale” means that it has a relatively smaller scale compared to the main grid. The microgrid can operate in juxtaposition/in parallel connection/grid-connectedly to an external power grid (such as a main grid, etc.), or can also operate alone. Generally speaking, the microgrid is an autonomous system which can realize self-control, self-protection and self-management.

There are usually various types of power generation units in the microgrid, such as a first energy power generation unit and a second energy power generation unit, etc. In this case, the first energy power generation unit is driven by renewable energy sources for example, and can be particularly embodied as an intermittent renewable energy power generation unit driven by intermittent renewable energy sources such as photovoltaic (PV) sources, wind power, etc.; and the second energy power generation unit is driven by for example traditional energy sources, such as coal, gas, diesel oil, small hydropower, etc. In particular, the intermittent renewable energy power generation unit is composed of an energy capturing device and a power electronic energy converting device, and is connected to the microgrid as a grid-connected unit. In this case, the power electronic energy converting device can be for example a converter or an inverter, etc, wherein the converter is used for performing general power conversion such as alternating current (AC) input to direct current (DC) output (i.e. AC/DC), DC/AC, DC/DC, AC/AC, etc., while the inverter is mainly used for realizing DC/AC conversion. Because the intermittent renewable energy power generation unit has the features of low energy density, high susceptibility to the weather and surrounding conditions, strong fluctuation in output power and low forecasting accuracy, the total installation capacity of intermittent renewable energy power generation units in the microgrid often suffers from a great limitation. If this limitation is exceeded, safe and stable operation of the microgrid cannot be ensured, and it may adversely cause instability to the external power grid connected thereto.

The conventional method for the intermittent renewable energy power generation unit to be connected to the microgrid is as shown in FIG. 1, which is also referred to as the first microgrid mode, wherein a power generator set using traditional energy sources (such as small hydropower, diesel generator, etc.) establishes and stabilizes the voltage and frequency of the microgrid, and the intermittent renewable energy power generation unit as a grid-connected unit is connected to the microgrid by way of current source control. In particular, FIG. 1 includes the following parts: an external power grid 11 and a microgrid 12. In this case, the external power grid 11 can be a main grid or a microgrid different from the microgrid 12. Furthermore, the microgrid 12 includes: one or more photovoltaic branches PV1, . . . , PVn, one or more wind power branches, a diesel or hydraulic generator 106, a load 107, and a switch 108. Furthermore, the photovoltaic branches, the wind power branches, the diesel or hydraulic generator 106 and the load 107 are all connected to the point of common coupling (PCC). Particularly, an AC bus is mounted on the PCC. Furthermore, each of the photovoltaic branches includes: a PV array 101 and a DC/AC inverter 102; and each of the wind power branches includes: a wind power generator 103, an AC/DC inverter 104, and a DC/AC inverter 105. In this mode, in order to ensure reliable and stable operation of the microgrid, the provision of a conventional power source with large capacity is required so as to maintain the stability of the voltage and frequency in the microgrid. In that case, the intermittent renewable energy power generation unit does not participate in the regulation of the voltage and frequency in the microgrid, which greatly limits the proportion of its total power generation capacity in the microgrid.

Based on the first microgrid mode, the German patent application DE 10 2005 023 290 A1, which is owned by SMA Germany, proposes a topology and control solution for a bidirectional battery inverter (referred to as bidirectional converter hereinafter) so as to improve the proportion of the power generation capacity of the intermittent renewable energy power generation unit in the microgrid. According to this patent application, the microgrid can be composed of the bidirectional converter and a conventional power generation unit (such as a diesel power generator set or a small hydraulic generator set) operating in parallel connection, which is the second microgrid mode shown in FIG. 2. In this mode, a battery set and the bidirectional converter are used as an energy regulation link to participate in the balance control of the active power in the microgrid, so that the connected proportion of the intermittent renewable energy power generation unit in the microgrid can be increased by way of regulating the active power in the microgrid and at the same time the operational stability of the microgrid can be ensured. The composition structure of FIG. 2 is similar to that of FIG. 1, and the difference lies in the fact that the microgrid in FIG. 2 further includes one or more battery branches, i.e. battery branch 1 to battery branch n, wherein the value of n can be set according to practical needs and it is not specifically defined here. Furthermore, each of the battery branches includes: a battery 209 and a bidirectional DC/AC inverter 210. However, because the power levels of the currently available bidirectional converter products are limited and due to technical reasons the number of bidirectional converters operating in parallel connection is also greatly limited, such a microgrid mode suffers from a strong limitation of its system capacity. Furthermore, in this microgrid mode, since the bidirectional converter achieves system frequency regulation by means of passive regulation of the active power, which causes hysteresis in power control, and the bidirectional converter has limited regulation effects on the reactive power, this microgrid mode cannot fundamentally solve the problem of low connected proportion of the intermittent renewable energy power generation unit in the microgrid.

### CONTENT OF THE INVENTION

In view of this, a power generation unit driver, a power generation unit and energy output equipment are proposed in the present invention, producing improved effects on the stability of power supply by a power grid when using an intermittent energy source. In order to achieve the above object, the technical solution provided by various embodiments of the present invention includes:

a power generation unit in a power grid, including:

a drive controller for generating a drive signal according to a first control signal and a second control signal obtained thereby;

a converter for transforming the input energy from a first voltage into a second voltage according to said drive signal, and outputting the same to an electric motor connected to said power generation unit driver;

wherein said first control signal is running condition information of said electric motor, and said second control signal includes the power grid frequency and/or the voltage amplitude of said power grid.

The running condition information of said electric motor includes one or any combination of the following: the armature voltage of the electric motor, the armature current of the electric motor, the rotor speed of the electric motor; and

said drive controller is used for generating said drive signal according to said power grid frequency and the running condition information of said electric motor.

The running condition information of said electric motor further includes the output torque of the electric motor, and said second control signal further includes the voltage amplitude of the power grid; and

said drive controller is used for generating said drive signal according to the information about the energy storage system in the power grid, the voltage amplitude of said power grid, said power grid frequency and the running condition information of said electric motor.

Said drive controller includes:

a rotating speed signal generation module for regulating the error signal between a given frequency and said power grid frequency, so as to obtain a rotating speed reference signal to be provided to a drive signal generation module;

wherein said drive signal generation module is used for generating said drive signal according to said rotating speed reference signal and the running condition information of said electric motor.

Said rotating speed signal generation module includes an automatic controller and an amplitude limiter.

Said converter is a direct current to alternating current inverter or a direct current to direct current converter.

A power generation unit in a power grid, including:

an energy capturing device for capturing one or more types of intermittent energy sources;

a charging controller for outputting a first voltage by utilizing the captured intermittent energy source;

a power generation unit driver for transforming said first voltage into a second voltage according to a first control signal inputted by an electric motor and a second control signal inputted by said power grid, so as to drive said electric motor;

wherein said electric motor is used for driving a synchronous generator to run under the effect of said second voltage; and

said synchronous generator is connected to the point of common coupling of the power grid for outputting the electric power generated thereby to the power grid.

The power generation unit further includes a transformer for transforming the second voltage generated by said power generation unit driver into a third voltage to be provided to said electric motor, with said electric motor being a medium or high voltage electric motor.

The power generation unit further includes an energy storage module;

wherein a first side of said charging controller is connected to said energy capturing device, a second side of said charging controller is connected to a first side of said power generation unit driver, and said energy storage module is connected to the second side of said charging controller and the first side of said power generation unit driver.

Said energy storage module includes an energy storage system and an energy storage managing device;

wherein said energy storage managing device is used for acquiring the information about said energy storage system, serving as a third control signal to be inputted into said power generation unit driver.

Said power generation unit driver is used for transforming said first voltage into said second voltage according to the third control signal inputted by said energy storage module, the first control signal inputted by said electric motor, and the second control signal inputted by said power grid.

Said first control signal includes the armature voltage of the electric motor, the armature current of the electric motor, the rotor speed of the electric motor, and the output torque of the electric motor; said second control signal includes the power grid frequency, the voltage amplitude of the power grid; and said third control signal includes the voltage of the energy storage system.

Said third control signal further includes the current of the energy storage system, the temperature of the energy storage system, and the state of charge of the energy storage system.

Said energy capturing device is a photovoltaic array, and said charging controller is a direct current to direct current converter; or

said energy capturing device is a wind power generator, and said charging controller is an alternating current to direct current converter.

The power generation unit includes a plurality of power generation unit branches;

wherein each of the power generation unit branches includes said energy capturing device, said charging controller, said energy storage module, said power generation unit driver, said electric motor, and said synchronous generator.

The power generation unit includes a plurality of energy input branches, wherein each of the energy input branches includes a switch, said energy capturing device and said charging controller, with said switch being arranged at the second side of said charging controller; and

said each energy input branch is connected to the first side of said power generation unit driver and said energy storage module via said switch.

The power generation unit includes a plurality of driving branches, wherein each of the driving branches includes a switch, said energy capturing device, said charging controller, said energy storage module and said power generation unit driver, with said switch being arranged at the second side of said power generation unit driver; and

said each driving branch is connected to said electric motor via said switch.

The power generation unit includes:

a plurality of energy input branches, wherein each of the energy input branches includes a first switch, said energy capturing device and said charging controller, with said first switch being arranged at the second side of said charging controller;

a plurality of energy output branches, wherein each of the energy output branches includes a second switch, said power generation unit driver, said electric motor, said synchronous generator, with said second switch being arranged at the first side of said power generation unit driver;

wherein said each energy input branch is connected to said energy storage module via said first switch, and said each energy output branch is connected to said energy storage module via said second switch.

Said power generation unit driver includes a second converter and a drive controller;

wherein said drive controller is used for generating a drive signal to be provided to said second converter according to said first control signal, said second control signal and said third control signal.

Said drive controller includes a rotating speed signal generation module and a drive signal generation module;

wherein said rotating speed signal generation module is used for regulating the error signal between a given frequency and said power grid frequency so as to obtain a rotating speed reference signal to be provided to said drive signal generation module, and said drive signal generation module generates said drive signal.

When said electric motor is an alternating current motor, said second converter is a direct current to alternating current inverter; or

when said electric motor is a direct current motor, said second converter is a direct current to direct current converter.

Energy output equipment in a power grid, including:

the above described power generation unit driver for transforming said first voltage into a second voltage according to a first control signal inputted by the electric motor and a second control signal inputted by said power grid, so as to drive said electric motor;

wherein said electric motor is used for driving a synchronous generator to run under the effect of said second voltage; and

said synchronous generator is connected to the point of common coupling of the power grid for outputting the electric power generated thereby to the power grid.

A microgrid includes the above power generation unit, with said power generation unit being connected to the point of common coupling of the micro grid; and

also includes one or more loads connected to said point of common coupling.

It can be seen from the above that the power generation unit driver, power generation unit, energy output equipment in a power grid provided in the embodiments of the present invention can achieve better effects on the stability of power supply of the power grid.

The above solution, technical features, advantages of the present invention and implementations thereof will be further described below in a clear and easily understood way by the description of the embodiments in conjunction with the accompanying drawings.

### DESCRIPTION OF THE ACCOMPANYING DRAWINGS

FIG. 1 is the topology structure of a conventional microgrid;

FIG. 2 is the topology structure of a microgrid with a bi-directional converter;

FIG. 3 is the topology structure of a microgrid using a self-synchronizing inverter;

FIG. 4a is a power generation unit driver built on the basis of the embodiments of the present invention;

FIG. 4b is a power generation unit built on the basis of the embodiments of the present invention;

FIG. 4c is the topology structure of a microgrid built on the basis of the embodiments of the present invention;

FIG. 5 is the composition structure of an energy input module in an embodiment of the present invention;

FIG. 6 is the composition structure of an energy output module in an embodiment of the present invention;

FIG. 7 is a structural schematic diagram of an alternating current driven power generation unit in an embodiment of the present invention;

FIG. 8 is the diagram of a control system for the alternating current driven power generation unit shown in FIG. 7;

FIG. 9 is the composition structure of an alternating current driver in the power generation unit shown in FIG. 7;

FIG. 10 is a structural schematic diagram of a direct current driven power generation unit in an embodiment of the present invention;

FIG. 11 is the composition structure of a direct current driver in the power generation unit shown in FIG. 10;

FIG. 12 is a structural schematic diagram of a power generation unit operating in a single branch in an embodiment of the present invention, in which the alternating current driver drives a medium or high voltage alternating current motor after voltage boosting by a transformer and then drives a synchronous generator;

FIG. 13 is a structural schematic diagram of a power generation unit operating in multiple branches in parallel connection in an embodiment of the present invention, in which the alternating current driver drives an alternating current motor and then drives the synchronous generator;

FIG. 14 is a structural schematic diagram of a power generation unit operating in multiple branches in parallel connection in an embodiment of the present invention, in which the direct current driver drives a direct current motor and then drives the synchronous generator;

FIG. 15 is a structural schematic diagram of a power generation unit in an embodiment of the present invention, in which a plurality of sets of alternating current drivers are connected in parallel on the energy storage side, jointly drive the alternating current motor, and then drive the synchronous generator;

FIG. 16 is a structural schematic diagram of a power generation unit in an embodiment of the present invention, in which a plurality of sets of direct current drivers are connected in parallel on the energy storage side, jointly drive the direct current motor, and then drive the synchronous generator;

FIG. 17 is a structural schematic diagram of a power generation unit in an embodiment of the present invention, in which a plurality of sets of alternating current drivers are connected in parallel on the output side, jointly drive the alternating current motor, and then drive the synchronous generator;

FIG. 18 is a structural schematic diagram of a power generation unit in an embodiment of the present invention, in which a plurality of sets of direct current drivers are connected in parallel on the output side, jointly drive the direct current motor, and then drive the synchronous generator;

FIG. 19 is a structural schematic diagram of a power generation unit operating with multiple branches in parallel and having a common energy storage system in an embodiment of the present invention, in which the alternating current driver drives an alternating current motor and then drives the synchronous generator; and

FIG. 20 is a structural schematic diagram of a power generation unit operating in multiple branches in parallel connection and having a common energy storage system in an embodiment of the present invention, in which the direct current driver drives a direct current motor and then drives the synchronous generator.

In particular, the reference signs used in the above figures are as follow:

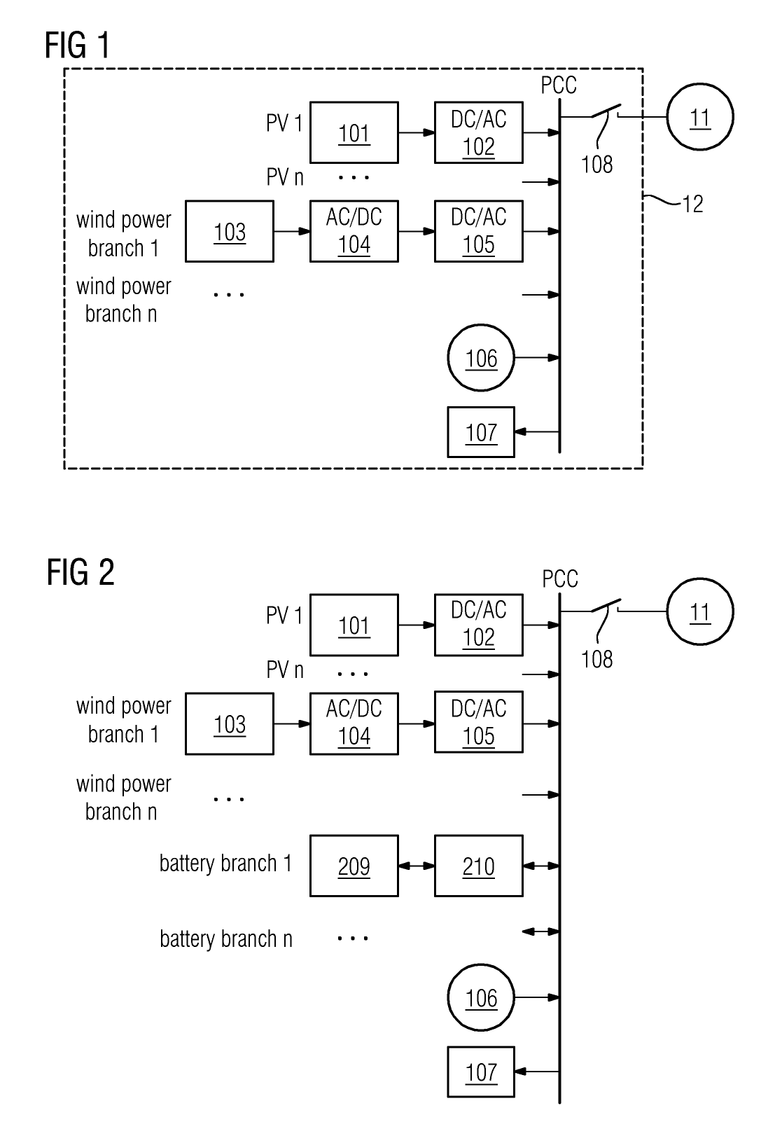

FIG. 1: external power network 11, microgrid 12, PV array 101, DC/AC inverter 102, wind power generator 103, AC/DC inverter 104, DC/AC inverter 105, diesel or hydraulic power generator 106, load 107, and switch 108;

FIG. 2: battery 209, bidirectional DC/AC inverter 210;

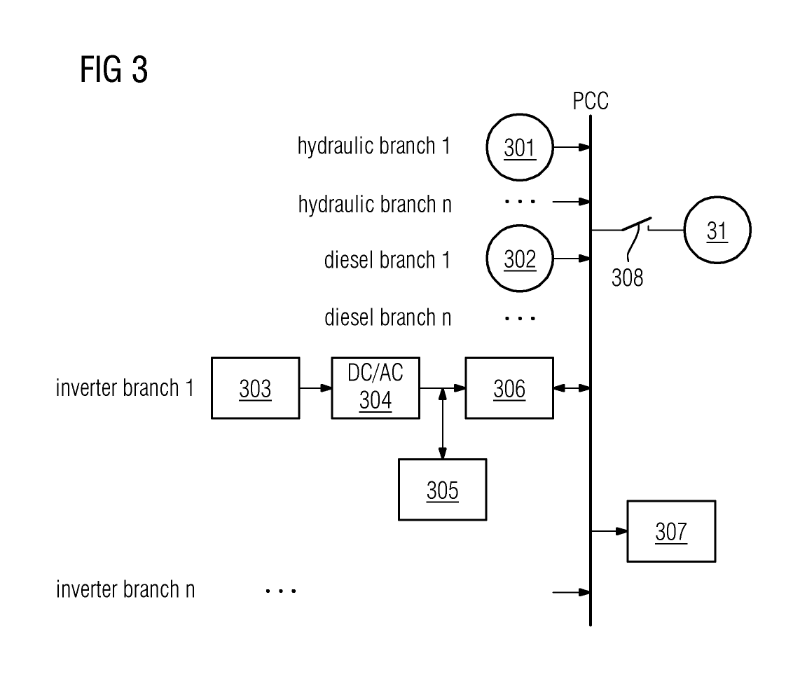

FIG. 3: external power network 31, hydraulic power generator 301, diesel power generator 302, PV array 303, DC/DC converter 304, battery 305, self-synchronizing inverter 306, load 307, and switch 308;

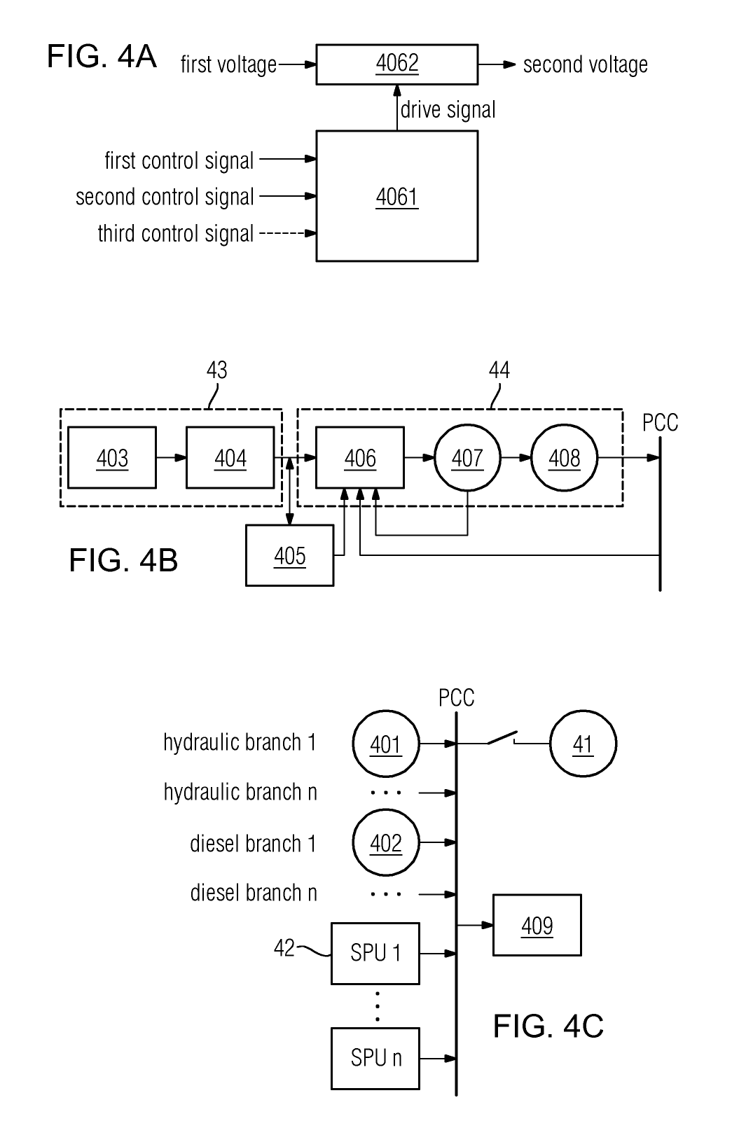

FIG. 4a-4c: external power network 41, SPU branch 42, energy input module 43, energy output module 44, hydraulic power generator 401, diesel power generator 402, energy capturing device 403, charging controller 404, energy storage module 405, power generation unit driver 406, motor 407, synchronous generator 408, load 409, driving controller 4061, and converter 4062;

FIG. 5: PV array 501, DC/DC converter 502, wind power generator 503, and AC/DC converter 504;

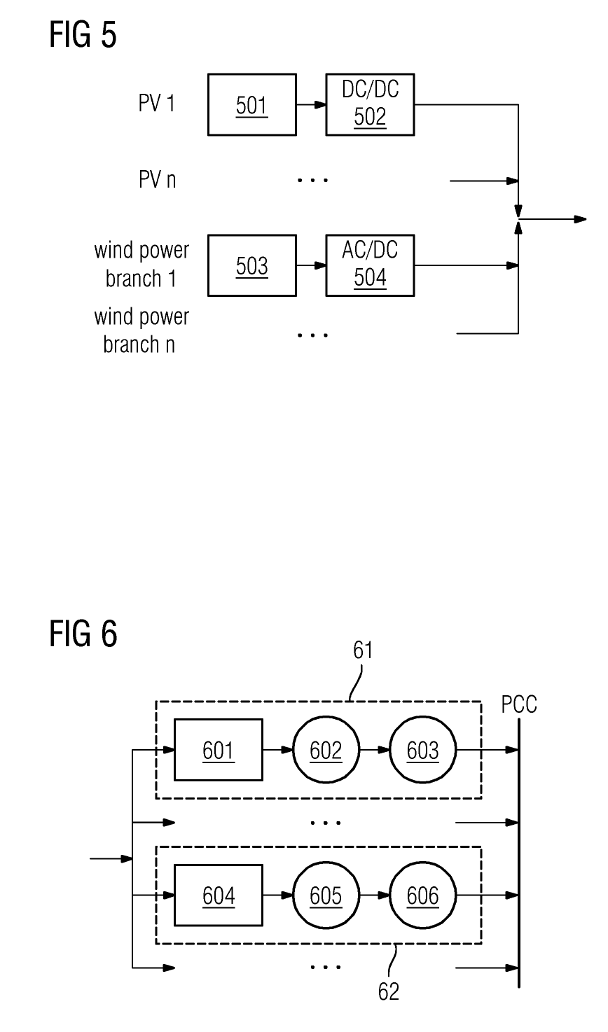

FIG. 6: first energy output sub-module 61, second energy output sub-module 62, SPU direct current driver 601, direct current motor 602, synchronous generator 603, SPU alternating current driver 604, alternating current motor 605, and synchronous generator 606;

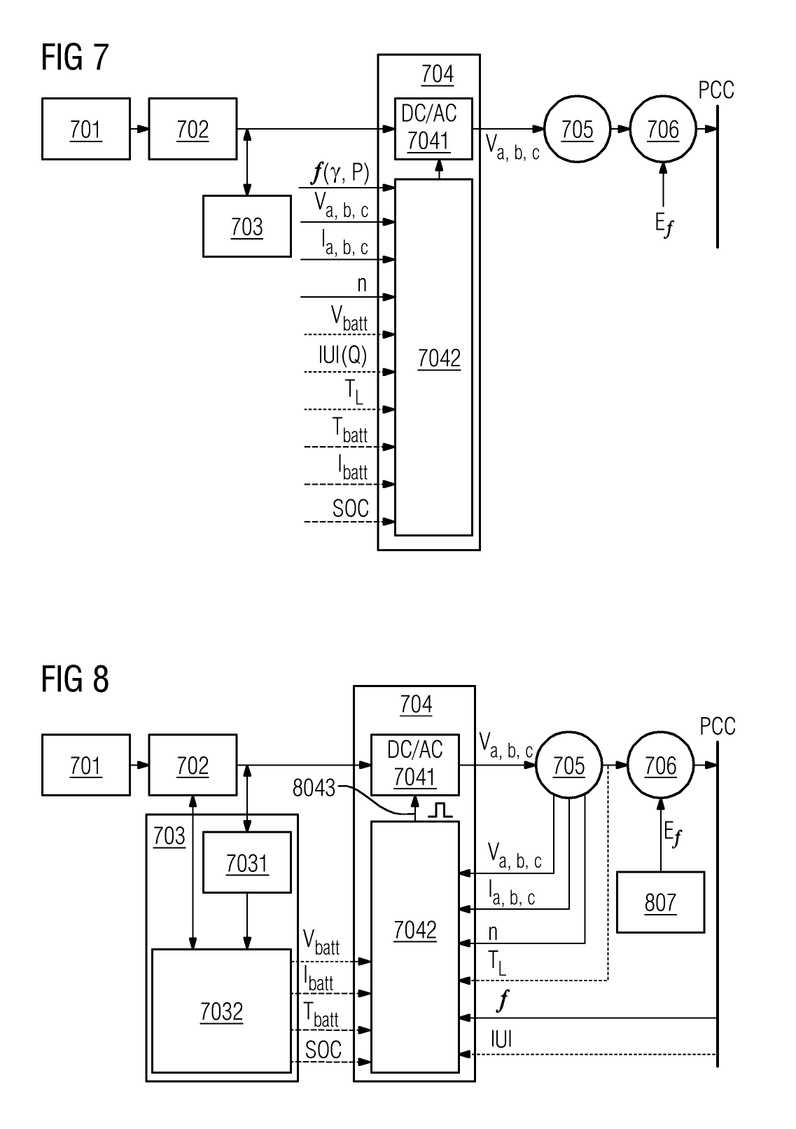

FIG. 7: energy capturing device 701, charging controller 702, energy storage module 703, SPU alternating current driver 704, alternating current motor 705, synchronous generator 706, DC/AC inverter 7041, driving controller 7042, energy storage system 7031, and energy storage manager 7032;

FIG. 8: excitation control system 807 and driving pulse 8043;

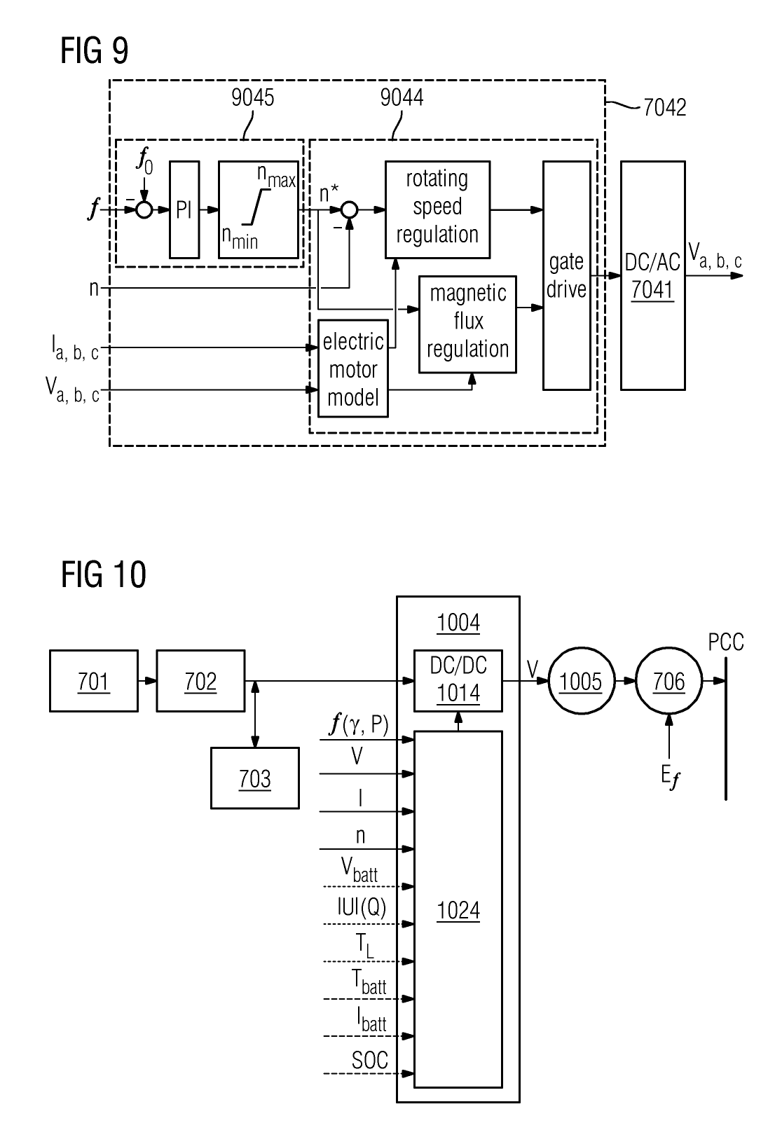

FIG. 9: drive signal generation module 9044 and rotating speed signal generation module 9045;

FIG. 10: SPU direct current driver 1004, direct current motor 1005, DC/DC converter 1014, and driving controller 1024;

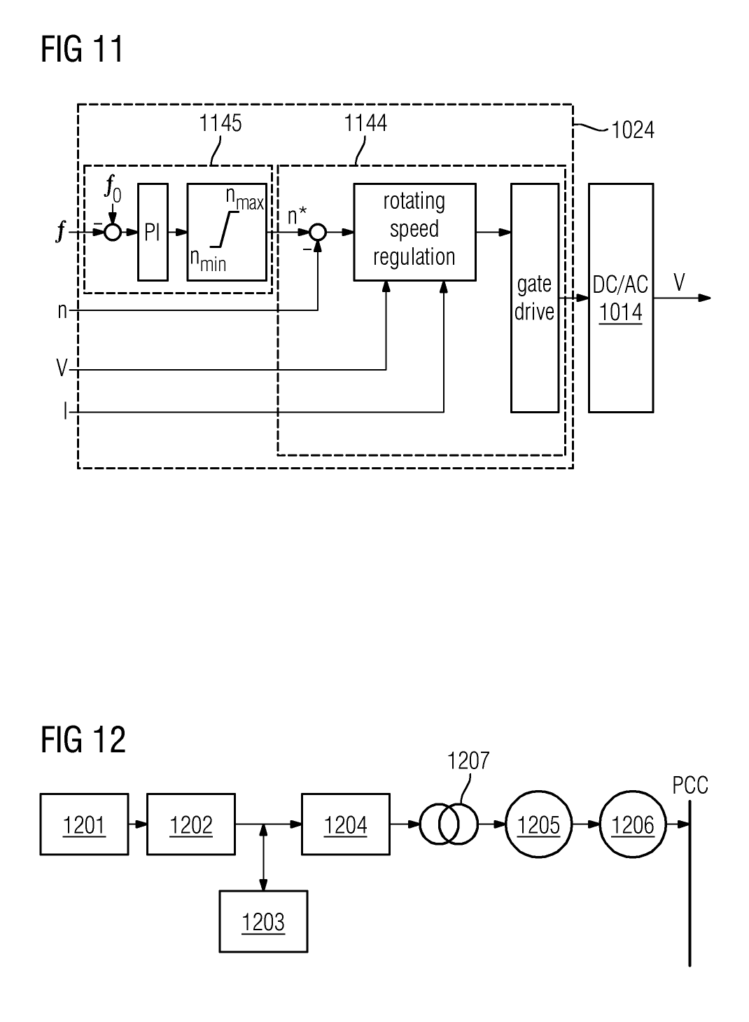

FIG. 11: drive signal generation module 1144 and rotating speed signal generation module 1145;

FIG. 12: energy capturing device 1201, charging controller 1202, battery 1203, SPU alternating current driver 1204, alternating current motor 1205, synchronous generator 1206, and transformer 1207;

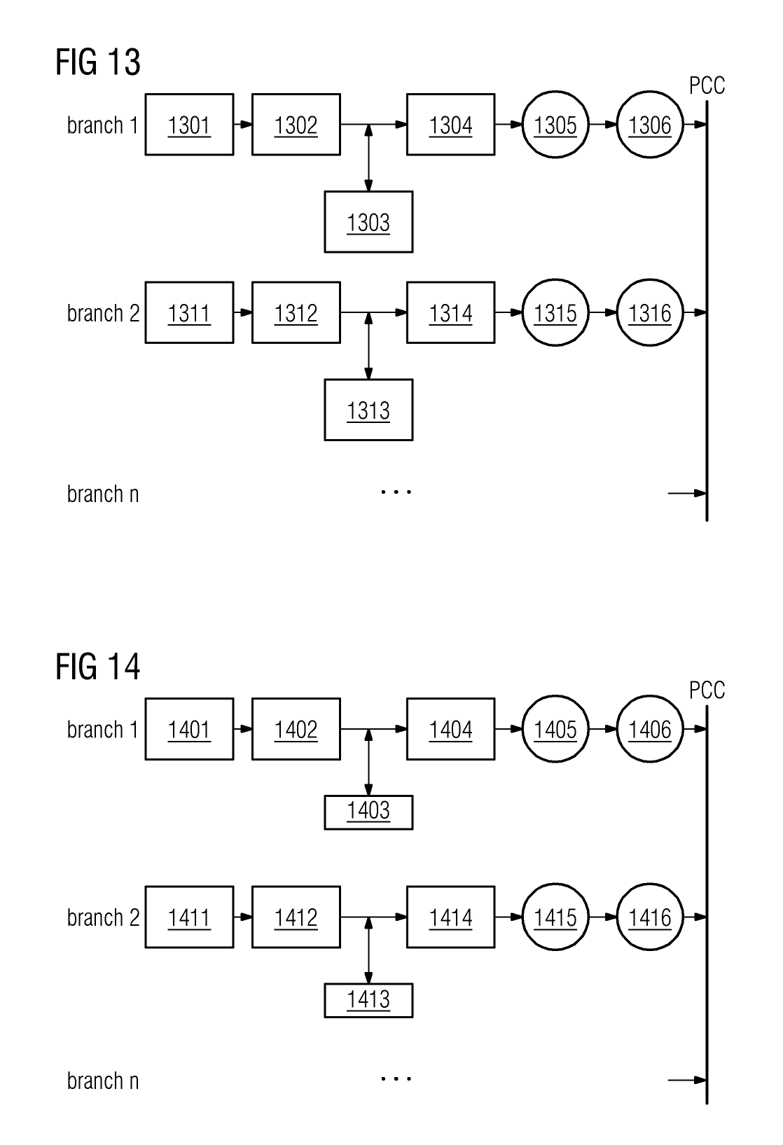

FIG. 13: energy capturing device 1301, charging controller 1302, battery 1303, SPU alternating current driver 1304, alternating current motor 1305, synchronous generator 1306, energy capturing device 1311, charging controller 1312, battery 1313, SPU alternating current driver 1314, alternating current motor 1315, and synchronous generator 1316;

FIG. 14: energy capturing device 1401, charging controller 1402, battery 1403, SPU direct current driver 1404, direct current motor 1405, synchronous generator 1406, energy capturing device 1411, charging controller 1412, battery 1413, SPU direct current driver 1414, direct current motor 1415, and synchronous generator 1416;

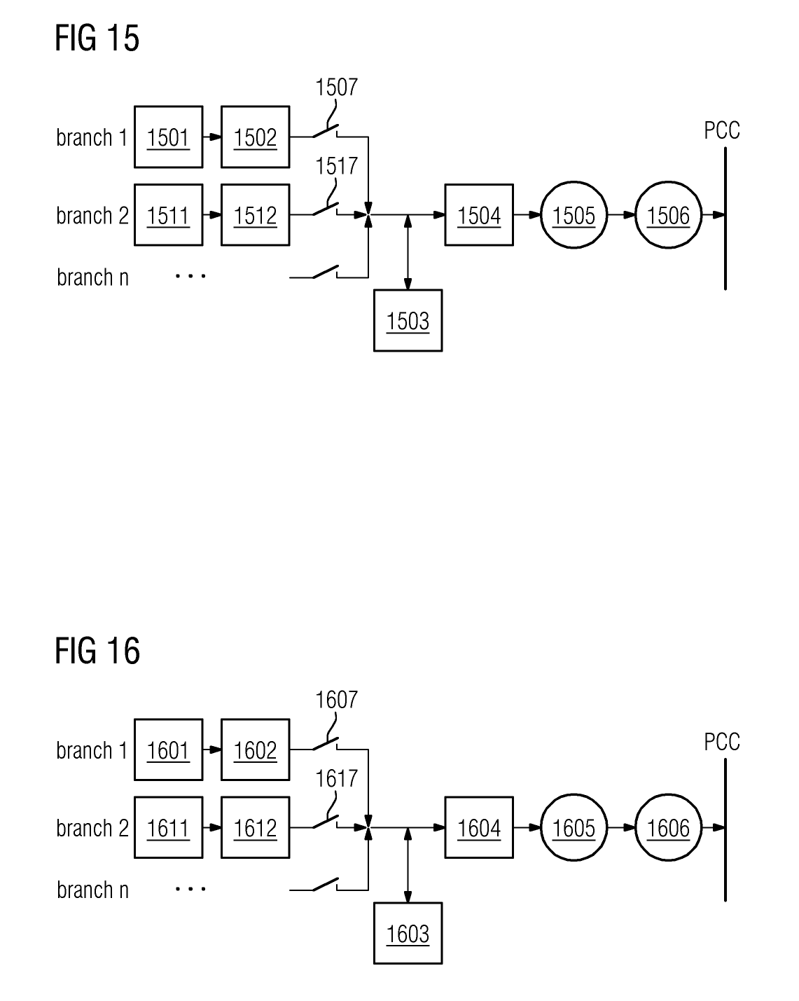

FIG. 15: energy capturing device 1501, charging controller 1502, battery 1503, SPU alternating current driver 1504, alternating current motor 1505, synchronous generator 1506, switch 1507, energy capturing device 1511, charging controller 1512, and switch 1517;

FIG. 16: energy capturing device 1601, charging controller 1602, battery 1603, SPU direct current driver 1604, direct current motor 1605, synchronous generator 1606, switch 1607, energy capturing device 1611, charging controller 1612, and switch 1617;

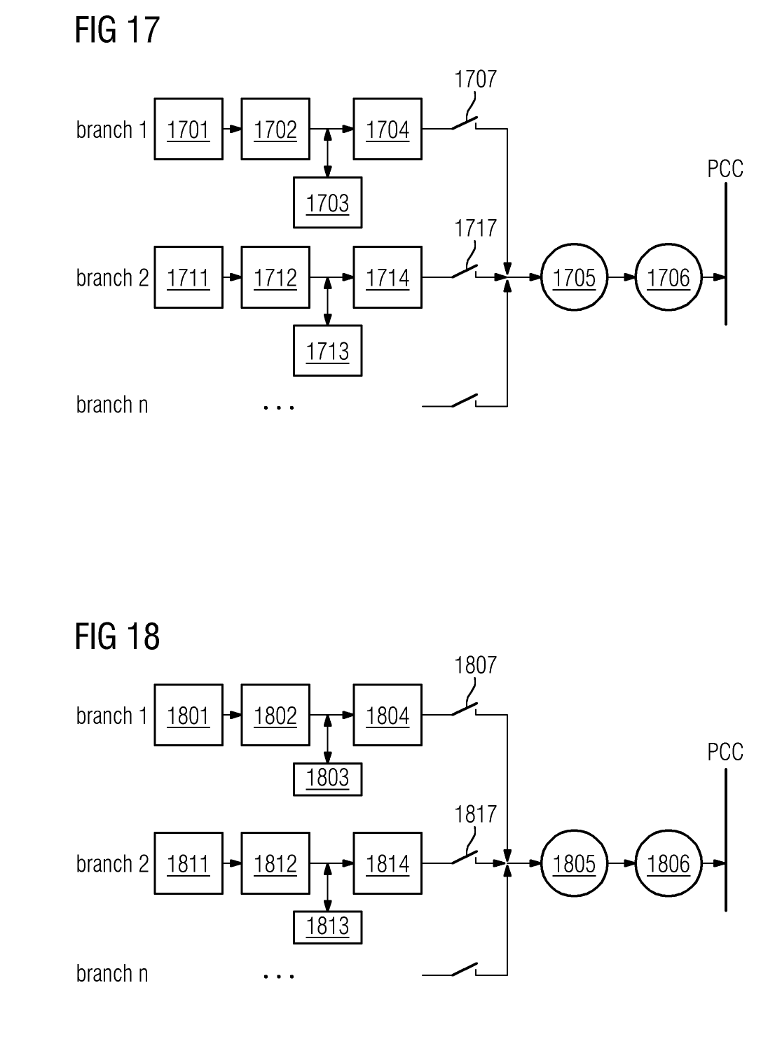

FIG. 17: energy capturing device 1701, charging controller 1702, energy storage module 1703, SPU alternating current driver 1704, alternating current motor 1705, synchronous generator 1706, switch 1707, energy capturing device 1711, charging controller 1712, energy storage module 1713, SPU alternating current driver 1714, and switch 1717;

FIG. 18: energy capturing device 1801, charging controller 1802, battery 1803, SPU direct current driver 1804, direct current motor 1805, synchronous generator 1806, switch 1807, energy capturing device 1811, charging controller 1812, battery 1813, SPU direct current driver 1814, and switch 1817;

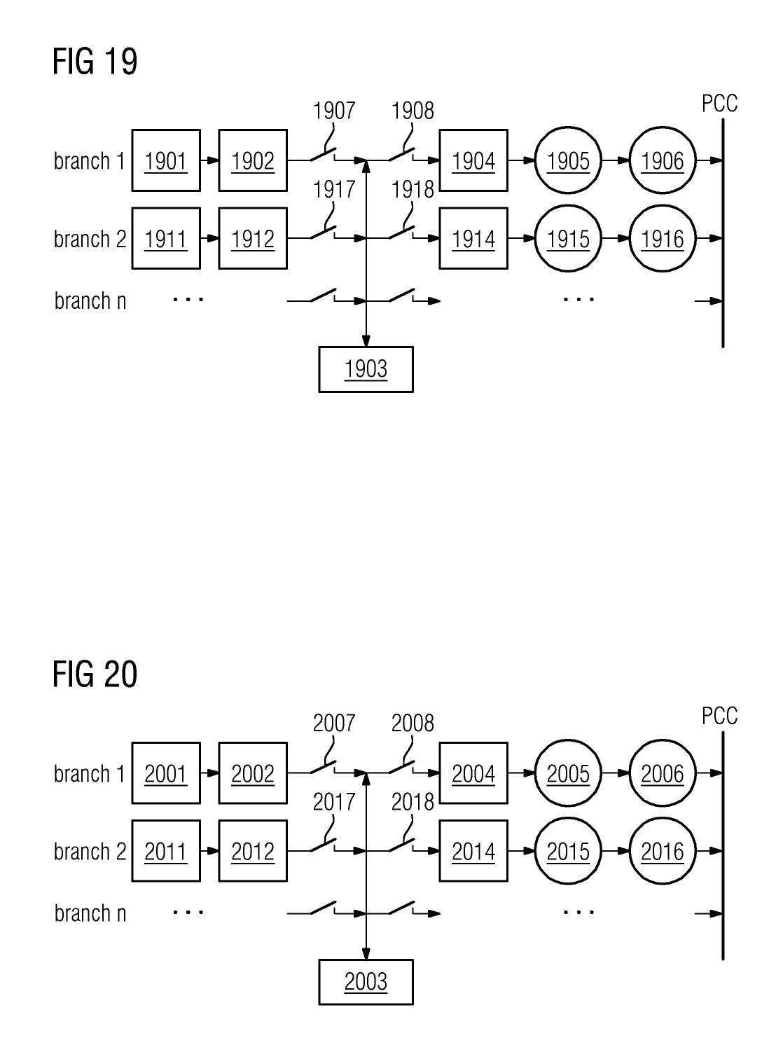

FIG. 19: energy capturing device 1901, charging controller 1902, battery 1903, SPU alternating current driver 1904, alternating current motor 1905, synchronous generator 1906, first switch 1907, second switch 1908, energy capturing device 1911, charging controller 1912, SPU alternating current driver 1914, alternating current motor 1915, synchronous generator 1916, first switch 1917, and second switch 1918;

FIG. 20: energy capturing device 2001, charging controller 2002, battery 2003, SPU direct current driver 2004, direct current motor 2005, synchronous generator 2006, first switch 2007, second switch 2008, energy capturing device 2011, charging controller 2012, SPU direct current driver 2014, direct current motor 2015, synchronous generator 2016, first switch 2017, and second switch 2018.

### PARTICULAR EMBODIMENTS

In order to make the object, technical solution and advantages of the present invention more apparent and clear, the present invention will be further described in detail below with reference to the accompanying drawings and by way of embodiments.

FIG. 3 shows a microgrid structure different from FIG. 1 or 2, i.e. a third microgrid mode, which includes the following parts: an external power grid 31, and a microgrid. Furthermore, the microgrid includes one or more hydraulic branches, one or more diesel branches, one or more inverter branches, a load 307 and a switch 308. Furthermore, each of the hydraulic branches includes a hydraulic generator 301, each of the diesel branches includes a diesel generator 302, and each of the inverter branches includes a PV array 303, a DC/DC converter 304, a battery 305 and a self-synchronizing inverter 306. In this case, the self-synchronizing inverter 306 can use a solution in which the automatic parallel operation of the voltage source inverters is achieved without depending on synchronizing signals and communication signals, which is proposed in U.S. Pat. No. 6,693,809 B2 owned by Germany ISET. According to the description of this patent, such an inverter has droop characteristics similar to those of conventional synchronous generator sets. Accordingly, such an inverter can operate in parallel connection with a diesel generator or a small hydraulic generator or other power generation units which have external characteristics of the synchronous generator so as to form a microgrid therewith. Particularly, in this microgrid structure, the self-synchronizing inverter 306 is in parallel connection with the small hydraulic generator 301 and both of them together participate in the regulation of the voltage and frequency of the microgrid. Theoretically, the capacity limitation of the intermittent renewable energy power generation unit in the microgrid can be drastically and effectively improved by this solution. However, currently this equipment is still in the research state, and there is no mature product available on the market.

Furthermore, a power generation unit driver in a power grid is proposed in the embodiments of the present invention. Particularly, such a power grid is mainly a microgrid and it can also be a main grid. As shown in FIGS. 4a and 4b, the power generation unit driver 406 includes a drive controller 4061 for generating a driving signal according to a first control signal and a second control signal obtained thereby, and a converter 4062 for transforming the input energy from a first voltage into a second voltage according to said drive signal and outputting the same to an electric motor 407 connected to said power generation unit driver 406, wherein said first control signal is running condition information of the electric motor 407, i.e. information related to the running condition of the electric motor 407, which can include one or more of the armature voltage of the electric motor, the armature current of the electric motor and the rotating speed of the electric motor rotor, and said second control signal includes the power grid frequency and/or the voltage amplitude of the power grid fed back by the power grid where the power generation unit driver 406 is located. Furthermore, the running condition information of said electric motor 407 includes the electric motor output torque T_{L}. Accordingly, the electric motor output torque T_{L} will be considered when a drive signal is generated by the drive controller 4061. During the practical implementation, each control signal can be obtained by the power generation unit driver 406 using a sensor. For example, the power generation unit driver 406 obtains the armature voltage V_{a,b,c} thereof from an alternating current motor by way of a plurality of sensors. For another example, the power generation unit driver 406 obtains the power grid voltage from the PCC by way of a plurality of sensors, and then the power grid frequency f is separated from the power grid voltage.

The power generation unit (SMART Power Unit, SPU) is driven for example by an intermittent energy source or a renewable energy source or an intermittent renewable energy source, etc. As shown in FIG. 4c, in a particular embodiment of the present invention, each of the SPU branches is a synchronous power generation unit driven by an intermittent renewable energy source, the external characteristics of the power generation unit are the same as those of the other conventional power generation units (such as a small hydraulic generator, a diesel generator, etc.), and the branches can operate in parallel connection together so as to supply power to a load 409 or in parallel connection with the external power grid 41. Of course, in the microgrid shown in FIG. 4c, conventional power generation units such as a hydraulic generator or a diesel generator, etc. may not be contained therein, instead, a plurality of SPU branches are in parallel connection and networked for operation. It should be noted that the SPU provided by the embodiments of the present invention is also capable of supplying power to the power grid steadily even if the energy source for driving the SPU shown in FIG. 4b has features such as unsteady output power, fluctuation, etc. Particularly, each of the SPU branches 42 shown in FIG. 4b includes an energy input module 43, an energy storage module 405 and an energy output module 44. In this case, the energy storage module 405 includes an energy storage system which can be a lead acid battery, Lithium battery, nickel metal hydride battery or other energy storage forms, and can also include an energy storage managing device for acquiring information about the energy storage system.

The energy input module 43 includes intermittent renewable energy source forms such as photovoltaic, wind power, tide, etc., and outputs a relatively steady direct current voltage by way of a corresponding power electronic controller. Particularly, the energy input module 43 includes an energy capturing device 403 for capturing one or more types of intermittent energy sources, and a charging controller 404. Furthermore, FIG. 5 shows an exemplary composition structure of the energy input module 43, which includes the following parts: one or more PV branches and one or more wind power branches. In this case, each of the PV branches includes a PV array 501, a DC/DC converter 502, and each of the wind power branches includes a wind power generator 503 (such as a windmill), and an AC/DC converter 504. It can be seen from FIG. 5 that the photovoltaic power generation is outputted by the DC/DC converter 502, the wind power generation is outputted by the AC/DC converter 504, and the energy storage module 405 can be charged by many kinds of energy sources in parallel connection.

The energy output module 44 includes a power generation unit driver (SPU driver) 406, an electric motor (motor) 407, a synchronous generator (SG) 408, and the energy output module 44 can constitute equipment and the power generation unit driver 406, the electric motor 407 and the synchronous generator 408 are all placed within the housing of the equipment. In this case, the electric motor 407 is used for converting electrical energy into mechanical energy. During the practical application, the electric motor is divided into a direct current motor and an alternating current motor according to different power sources being used. The synchronous generator 408 is used for converting mechanical energy into electrical energy, and the rotor and stator thereof keep synchronous speed in rotation. It should be noted that the electric motor 407 and the synchronous generator 408 per se can be achieved by utilizing conventional techniques, which will not be described here redundantly. During the practical operation, the power generation unit driver can drive an alternating current motor (or a direct current motor), drive the synchronous generator to run, and then output the industrial frequency electrical energy (the output frequency thereof is 50 Hz or 60 Hz). FIG. 6 shows an exemplary composition structure of the energy output module 44 which includes the following parts: one or more first energy output sub-module 61 and one or more second energy output sub-module 62. Furthermore, each of the first energy output sub-modules 61 includes an SPU direct current driver 601, a direct current motor 602 and a synchronous generator 603, and each of the second energy output sub-modules 62 includes an SPU alternating current driver 604, an alternating current motor 605 and a synchronous generator 606.

In FIG. 4b, cable connection is used between the energy capturing device 403 and the charging controller 404, between the charging controller 404 and the power generation unit driver 406, between the energy storage module 405 and the charging controller 404 and the power generation unit driver 406, between the power generation unit driver 406 and the electric motor 407, and between the synchronous generator 408 and PCC, wherein the arrows represent the flow direction of the energy, and mechanical connection is used between the electric motor 407 and the synchronous generator 408.

It can be seen from FIG. 4b that the power generation unit 42 built on the basis of the embodiments of the present invention has the following major features: (a) it has output external characteristics similar to those of the conventional power generation units; (b) the last stage of energy output is a synchronous generator; and (c) it is energized by an intermittent renewable energy source, and the electric motor is driven by the power electronic converter and then drives the synchronous generator to run.

Particularly, the power regulation for the SPU shown in FIG. 4b is divided into active power regulation and inactive power regulation. In this case, the active power regulation is achieved by the power generation unit driver 406 so as to ensure the stability of the power grid frequency, and the inactive power regulation is achieved by the excitation control system of the synchronous generator 408 per se. For the inactive power regulation, the synchronous generator 408 regulates its own excitation voltage by judging the change conditions of the power grid voltage amplitude, so as to control the output voltage of the synchronous generator 408, ensure the stability of the voltage amplitude of the power grid, and achieve the object of regulating the power generation unit to output inactive power.

The major function of the power generation unit driver 406 includes: judging the possible running condition of the next moment by acquiring the current running condition information of each composition part of the microgrid, and giving the next moment drive signal of the electric motor 407 by the corresponding drive controller logic so as to ensure stable operation of the whole power generation unit. Particularly, the power generation unit driver 406 acquires the information about the microgrid within the present control cycle (such as the power grid frequency, voltage amplitude, etc.), the running condition information about the electric motor (such as armature voltage, current, rotor rotating speed, output torque, etc.) and information about the energy storage system (such as voltage, current, temperature, etc.), and gives the drive pulse signal for the next control cycle by the corresponding drive control logic so as to achieve the object of regulating the power generation unit to output active power. For example, if the power grid frequency at the present moment t1 rises relative to the previous moment t0, then the rotating speed of the electric motor is decreased by the drive signal generated by the power generation unit driver 406 so that the power grid frequency at the next moment t2 is decreased to ensure the stability of the power grid.

Particularly, FIG. 4c shows an exemplary power grid structure constructed on the basis of the SPU, which includes the following parts: an external power grid 41 and a microgrid. Furthermore, the microgrid includes one or more hydraulic branches, one or more diesel branches, one or more SPU branches 42, and a load 409. It can be seen that it is a microgrid structure different from the first to the third microgrid modes, and the microgrid structure shown in FIG. 4c can be referred to as the fourth microgrid mode for the sake of distinction. Furthermore, each of the hydraulic branches includes a hydraulic generator 401, and each of the diesel branches includes a diesel generator 402.

Furthermore, FIG. 7 shows an exemplary composition structure of the SPU branch 42, which SPU branch 42 is an alternating current driven power generation unit, including the following parts: an energy capturing device 701, a charging controller 702, an energy storage module 703, an SPU alternating current driver 704, an alternating current motor 705 and a synchronous generator 706. Furthermore, the SPU alternating current driver 704 includes: a DC/AC inverter 7041 and a drive controller 7042. Furthermore, the drive controller 7042 has the following inputs: the voltage V_{batt} of the battery set; the armature voltage V_{a, b, c} of the alternating current motor; the armature current I_{a, b, c} of the alternating current motor; the rotor rotating speed n of the alternating current motor (or the rotor position angle θ); the output torque T_{L} of the alternating current motor; the power grid frequency f(γ, P), in which γ is the power angle of the synchronous generator and P is active power; the voltage amplitude |U| (Q) of the power grid, in which Q is inactive power; the temperature T_{batt} of the battery set, which input is optional; the battery set current I_{batt}, which input is optional; and the state of charge SOC of the battery, which input is optional. Furthermore, the voltage applied to the synchronous generator 706 in FIG. 7 is the excitation voltage E_{f}. It should be noted that it is easy to change the frequency of the alternating current driven power generation unit and regulate the speed thereof.

Particularly, FIG. 8 is an exemplary connection of the SPU branch 42 shown in FIG. 7. For the drive controller 7042, inputs such as the voltage V_{batt} of the battery set, the temperature T_{batt} of the battery set, the current I_{batt} of the battery set, the state of charge SOC of the battery, etc. are provided by the energy storage managing device 7032 in the energy storage module 703, wherein the temperature T_{batt} of the battery set, the current T_{batt} of the battery set, the state of charge SOC of the battery are optional inputs, shown with thick broken lines in FIG. 8; inputs such as the power grid frequency f, the voltage amplitude |U| of the power grid, etc. are provided by the PCC; and inputs such as the armature voltage V_{a, b, c} of the alternating current motor, the armature current I_{a, b, c} of the alternating current motor, the rotor rotating speed n of the alternating current motor, etc. are provided by the alternating current motor 705. Furthermore, the energy storage managing device 7032 acquires parameters from the energy storage system 7031 and/or receives the control signals provided by the charging controller 702. Of course, the energy storage managing device 7032 can also provide control signals to the charging controller 702. Furthermore, the drive controller 7042 can provide the drive pulse 8043 to the DC/AC inverter 7041. For the synchronous generator 706, the synchronous generator excitation voltage E_{f} applied thereon is provided by the excitation control system 807.

It needs to be pointed out that the driving control logics used in the power generation unit driver 406 have a variety of implementations, and the implementation of the power regulation of the power generation unit is described below by taking the conventional proportional integral (PI) control algorithm as an example. In particular, FIG. 9 is an exemplary composition structure of the SPU alternating current driver 704 shown in FIG. 7, including the following parts: a DC/AC inverter 7041 and a drive controller 7042. Furthermore, the drive controller 7042 includes a drive signal generation module 9044 and a rotating speed signal generation module 9045. In this case, f₀ is the given frequency of the system and n* is the rotating speed reference of the electric motor. During the practical application, the PI controller in the rotating speed signal generation module 9045 can be replaced with another type of automatic controller, such as a fuzzy controller, a repeated controller, a proportional controller, a proportional-differential (PD) controller, and a proportional-integral-differential (PID) controller, etc. A particular implementation of the drive signal generation module 9044 is as shown in FIG. 9, and other conventional implementations can also be used, which will not be described here redundantly.

That is, for a power generation unit driven by an alternating current motor, i.e. an alternating current driven power generation unit, as shown in FIG. 9, the power generation unit driver 704 samples signals such as power grid frequency f, armature voltage V_{a,b,c}, armature current I_{a,b,c}, rotor speed n and output torque T_{L} of the alternating current motor, and the voltage V_{batt}, current I_{batt} and temperature T_{batt} of the battery set, etc. The error signals of the given frequency f₀ of the system and power grid frequency f are regulated by the PI controller and the amplitude limiter to obtain the rotating speed reference signal n* of the alternating current motor 705. This rotating speed reference signal is inputted to the drive controller 7042 simultaneously with the armature voltage, armature current, and the rotor speed signals of the alternating current motor and the voltage signal of the battery, and calculated to obtain the drive signal of the DC/AC inverter 7041 and to drive the alternating current motor 705 to regulate the rotating speed, achieving the object of regulating the power generation unit to output active power. In particular, the drive controller 7042 can be achieved by using a digital signal processor, a microprocessor control unit (MCU) or a single-chip microcomputer, etc.

FIG. 10 is a structural schematic diagram of a power generation unit driven by a direct current motor in an embodiment of the present invention, i.e. a direct current driven power generation unit, the composition of which is generally similar to that of the alternating current driven power generation unit shown in FIG. 7. The difference lies in the fact that FIG. 10 includes an SPU direct current driver 1004 and a direct current motor 1005. Furthermore, the SPU direct current driver 1004 includes a DC/DC inverter 1014 and a drive controller 1024. The difference from the drive controller 7042 in FIG. 7 lies in the fact that the drive controller 1024 in FIG. 10 has inputs such as the armature voltage V of the direct current motor, the armature current I of the direct current motor, and the rotor speed n of the direct current motor, etc. It needs to be pointed out that the control logic of the direct current driven power generation unit is simple.

For a direct current driven power generation unit, as shown in FIG. 11, the power generation unit driver 1004 acquires signals such as power grid frequency, armature voltage, armature current, rotor speed and output torque of the direct current motor, and the voltage signal of the battery set, etc. Furthermore, the error signals of the given frequency of the system and the power grid frequency are regulated by the PI controller and the amplitude limiter to obtain the rotating speed reference signal of the direct current motor. This rotating speed reference signal is inputted into the digital signal processor 1024 simultaneously with the armature voltage, armature current and rotor speed signals of the direct current motor and the voltage signal of the battery, and calculated to obtain the drive signal of the DC/DC inverter 1014 and to drive the direct current motor 1005 to regulate the rotating speed, achieving the object of regulating the power generation unit to output active power. In this case, a particular implementation of the drive signal generation module 1144 is as shown in FIG. 11, and reference can also be made to other conventional implementations, which will not be described redundantly.

It needs to be pointed out that the power generation units provided in the embodiments of the present invention not only can increase the power generation capability proportion of intermittent renewable energies in the microgrid, but also can control the stability of the microgrid. Particularly speaking:

(1) Since the power generation units provided in the embodiments of the present invention are provided with synchronous generators 408, when small disturbances occur in the microgrid frequency, the microgrid frequency can automatically return to the balanced state by way of the electromechanical properties of the synchronous generators 408 per se, for example, the rotor inertia of the synchronous generators 408 can absorb small disturbances.

(2) When large disturbances occur in the power grid frequency, the power generation units provided in the embodiments of the present invention regulate the active power outputted by the synchronous generators 408 according to the detected variations in the microgrid frequency and make the microgrid frequency reach a steady value.

(3) When relatively large sudden changes occur in the power grid frequency, the power generation units provided in the embodiments of the present invention rapidly regulate the active power outputted by the synchronous generators 408 according to the detected variations in the microgrid frequency to keep the microgrid frequency steady.

(4) When fluctuations occur in the microgrid voltage, the power generation units provided in the embodiments of the present invention regulate the excitation voltage E_{f} of the synchronous generators 408 according to the detected variations in the voltage amplitude of the system to ensure the stability of the microgrid voltage.

(5) When there are short-term fluctuations in the output power of renewable energy sources as a result of the weather and environment conditions, the unsteady input voltage is converted into relatively steady direct current voltage under the effect of the charging controller 404 in the energy input module 43, so as to provide charging control to the energy storage module 405. Furthermore, the energy storage module 405 provides energy buffering, achieving dynamic decoupling of the input energy and output energy, and eliminating the influence of the short-term fluctuations in the output power of renewable energy sources.

(6) During the relatively long-term charging and discharging of the energy storage module 405, the port voltage thereof varies correspondingly. By way of the rational design of the voltage level of the energy storage module 405 and motor 407, the power generation unit driver 406 can have enough operating voltage under extreme operating conditions, which ensures that steady drive power is provided to the motor 407 at the subsequent stage.

Furthermore, based on the power generation units provided in FIGS. 7 and 10, a variety of different power generation unit topological structures can be obtained by modification. In this case, FIG. 7 is as follows: a power generation unit operating in a single branch in an embodiment of the present invention, in which an alternating current driver directly drives a low-voltage alternating current motor and then drives a synchronous generator; and FIG. 10 is a power generation unit operating in a single branch in an embodiment of the present invention, in which a direct current driver directly drives a direct current motor and then drives a synchronous generator. FIGS. 12 to 20 are all topological structures after deformation in the embodiments of the present invention.

FIG. 12 is a structural schematic diagram of a power generation unit operating in a single branch in an embodiment of the present invention, in which an alternating current driver is increased in voltage by a transformer and then drives a high-voltage alternating current motor and then drives a synchronous generator. In FIG. 12, the power generation unit has only one branch, and particularly includes the following parts: an energy capturing device 1201, a charging controller 1202, a battery 1203, an SPU alternating current driver 1204, an alternating current motor 1205, a synchronous generator 1206, and a transformer 1207. In particular, the transformer 1207 is used for converting the second voltage generated by said SPU alternating current driver 1204 into a third voltage to be provided to said alternating current motor 1205. It needs to be pointed out that a medium or high voltage alternating current motor provides higher power, and smaller current and thus less loss.

FIG. 13 is a structural schematic diagram of a power generation unit operating in multiple branches in parallel in an embodiment of the present invention, in which an alternating current driver drives an alternating current motor and then drives a synchronous generator. In FIG. 13, the power generation unit has multiple power generation unit branches, and each of the power generation unit branches has the same composition as in FIG. 7, which will not be described here redundantly. It can be seen that the total power generation capability of intermittent energy sources can be increased using multiple power generation unit branches.

FIG. 14 is a structural schematic diagram of a power generation unit operating in multiple branches in parallel connection in an embodiment of the present invention, in which a direct current driver drives a direct current motor and then drives a synchronous generator. In FIG. 14, the power generation unit has multiple power generation unit branches, and each of the power generation unit branches has the same composition as FIG. 10, which will not be described here redundantly.

FIG. 15 is a structural schematic diagram of a power generation unit in an embodiment of the present invention, in which multiple sets of alternating current drivers in parallel connection on the energy storage side together drive an alternating current motor and then drive a synchronous generator. It needs to be pointed out that the side of the alternating current driver that is connected to the battery is referred to as the energy storage side (or referred to as the first side), and the side that is connected to the motor is referred to as the output side (or referred to as the second side). In FIG. 15, the power generation unit includes the following parts: multiple energy input branches including an energy capturing device, a charging controller, and a switch, a battery 1503, an SPU alternating current driver 1504, an alternating current motor 1505, and a synchronous generator 1506. In this case, the first energy input branch includes: an energy capturing device 1501, a charging controller 1502 and a switch 1507; while the second energy input branch includes: an energy capturing device 1511, a charging controller 1512 and a switch 1517. It can be seen that by way of the distributed input as shown in FIG. 15, the power generation units provided in the embodiments of the present invention are more flexible to install, not limited by locations.

FIG. 16 is a structural schematic diagram of a power generation unit in an embodiment of the present invention, in which multiple sets of direct current drivers in parallel connection on the energy storage side together drive a direct current motor and then drive a synchronous generator. It needs to be pointed out that the composition of FIG. 16 is similar to that in FIG. 15, and the difference lies in the fact that an SPU direct current driver 1604 is used to drive a direct current motor 1605 in FIG. 16.

FIG. 17 is a structural schematic diagram of a power generation unit in an embodiment of the present invention, in which multiple sets of alternating current drivers in parallel connection on the output side together drive an alternating current motor and then drive a synchronous generator. In FIG. 17, the power generation unit includes the following parts: multiple drive branches including an energy capturing device, a charging controller, a battery, an SPU alternating current driver and a switch, an alternating current motor 1705, and a synchronous generator 1706. A first drive branch includes: an energy capturing device 1701, a charging controller 1702, an energy storage module 1703, an SPU alternating current driver 1704 and a switch 1707; while a second drive branch includes: an energy capturing device 1711, a charging controller 1712, an energy storage module 1713, an SPU alternating current driver 1714 and a switch 1717. It can be seen that FIG. 17 shows a motor provided with multiple drivers, in order to solve the power mismatch problem of the motor and the drivers, making the combination of power generation units more flexible and easy to upgrade.

FIG. 18 is a structural schematic diagram of a power generation unit in an embodiment of the present invention, in which multiple sets of direct current drivers in parallel connection on the output side together drive a direct current motor and then drive a synchronous generator. It needs to be pointed out that the composition of FIG. 18 is similar to that in FIG. 17, and the difference lies in the fact that an SPU direct current driver 1804 is used to drive a direct current motor 1805 in FIG. 18.

FIG. 19 is a structural schematic diagram of a power generation unit operating in multiple branches in parallel connection and sharing an energy storage system in an embodiment of the present invention, in which an alternating current driver drives an alternating current motor and then drives a synchronous generator. In FIG. 19, the power generation unit includes the following parts: multiple energy input branches including an energy capturing device, a charging controller, and a first switch, a battery 1903, and multiple energy output branches including a second switch, an SPU alternating current driver, an alternating current motor, and a synchronous generator. A first energy input branch includes: an energy capturing device 1901, a charging controller 1902 and a first switch 1907; while a second energy input branch includes: an energy capturing device 1911, a charging controller 1912 and a first switch 1917. Furthermore, the first energy output branch includes: a second switch 1908, an SPU alternating current driver 1904, an alternating current motor 1905, and a synchronous generator 1906; while the second energy output branch includes: a second switch 1918, an SPU alternating current driver 1914, an alternating current motor 1915 and a synchronous generator 1916. It can be seen that multiple input branches in parallel connection mean that a certain input branch can be cut off for maintenance when it has a failure, without affecting the operation of the whole power generation unit, and multiple output branches in parallel connection render the increase or decrease of the output easier to control, thereby increasing the operating efficiency of the power generation unit.

FIG. 20 is a structural schematic diagram of a power generation unit operating in multiple branches in parallel and sharing an energy storage system in an embodiment of the present invention, in which a direct current driver drives a direct current motor and then drives a synchronous generator. It needs to be pointed out that the composition of FIG. 20 is similar to that in FIG. 19, and the difference lies in the fact that an SPU direct current driver 2004 is used to drive a direct current motor 2005 in FIG. 20.

It can be seen from the technical solutions recorded above that:

1) In the power generation units in the embodiments of the present invention, a synchronous generator is used to achieve energy output, and the microgrid system has good stability, which is advantageous for power decoupling control.

2) The power generation units in the embodiments of the present invention have auto-synchronous properties, by which it can be convenient to achieve the introducing or withdrawing of multiple power generation units when in parallel connection, and it is convenient to extend the capability of the system.

3) The power generation units in the embodiments of the present invention have an electromechanical link as the last stage, and as compared to the traditional power generation units having power electronic devices as the last stage, they have a significant increase in the average interruption-free operation time, a significant increase in the yearly average operation hours, and also a significant increase in the power generation amount per year.

4) Due to the presence of the electromechanical link, the transient fluctuations which are not the control targets, occurring in the power electronic drivers per se of the power generation units, can also be absorbed by the next-stage electromechanical link, eliminating the influence on the quality of the electrical energy outputted by the power generation unit.

5) When establishing a microgrid structure, the power generation units in the embodiments of the present invention have a plurality of flexible combinations.

6) Based on the microgrid system established in the embodiments of the present invention, the limit on the penetration power capability of renewable energy resources in the microgrid can be increased to a large extent (theoretically speaking, up to 100%), the use and consumption of fossil energy resources can be reduced to a large extent, having good benefits in environmental protection.

The present invention has been illustrated and described above in detail by way of the drawings and embodiments, however, the present invention is not limited to these disclosed embodiments, and other solutions derived therefrom by those skilled in the art are within the scope of protection of the present invention.

1-17. (canceled)

18. A power generation unit driver in a power grid, the power generation unit driver comprising:
a drive controller configured for generating a drive signal according to a first control signal and a second control signal obtained thereby;
a converter for transforming an input energy from a first voltage to a second voltage according to the drive signal, and outputting the second voltage to an electric motor connected to the power generation unit driver;
wherein the first control signal is about a running condition information of the electric motor, and the second control signal includes at least one of a power grid frequency or a voltage amplitude of the power grid.

19. The power generation unit driver according to claim 18, wherein the running condition information of the electric motor includes one or any combination selected from the group consisting of: an armature voltage of the electric motor, an armature current of the electric motor, and a rotor speed of the electric motor.

20. The power generation unit driver according to claim 18, wherein said drive controller comprises:
a rotating speed signal generation module for closed-loop control of an error signal between a given frequency and the power grid frequency, so as to obtain a rotating speed reference signal to be provided to a drive signal generation module; and
wherein said drive signal generation module is configured for generating the drive signal according to the rotating speed reference signal and the running condition information of the electric motor.

21. The power generation unit driver according to claim 20, wherein said rotating speed signal generation module comprises an automatic controller and an amplitude limiter.

22. The power generation unit driver according to claim 18, wherein said converter is a direct current to alternating current inverter or a direct current to direct current converter.

23. A power generation unit in a power grid, the power generation unit comprising:
an energy capturing device for capturing one or more types of intermittent energy sources;
a charging controller for outputting a first voltage by utilizing the intermittent energy source captured;
a power generation unit driver for transforming the first voltage into a second voltage in accordance with a first control signal input by an electric motor and a second control signal input by the power grid, so as to drive the electric motor;
wherein the electric motor is connected for driving a synchronous generator to run under the effect of the second voltage; and
the synchronous generator is connected to a point of common coupling of the power grid for outputting the electric power generated thereby to the power grid.

24. The power generation unit according to claim 23, which further comprises a transformer for transforming the second voltage generated by said power generation unit driver into a third voltage and then providing the third voltage to the electric motor, with the electric motor being a medium or high voltage motor.

25. The power generation unit according to claim 23, which further comprises:
an energy storage module;
wherein a first side of said charging controller is connected to said energy capturing device, a second side of said charging controller is connected to a first side of said power generation unit driver, and said energy storage module is connected to the second side of said charging controller and to the first side of said power generation unit driver.

26. The power generation unit according to claim 25, wherein
said energy storage module comprises an energy storage system and an energy storage managing device;
said energy storage managing device being configured to acquire the information about said energy storage system, serving as a third control signal to be input into said power generation unit driver; and
said power generation unit driver being configured for transforming the first voltage into the second voltage in accordance with the third control signal input by said energy storage module, the first control signal input by the electric motor, and the second control signal input by the power grid.

27. The power generation unit according to claim 26, wherein
the first control signal includes an armature voltage of the electric motor, an armature current of the electric motor, a rotor speed of the electric motor, an output torque of the electric motor;
the second control signal includes a power grid frequency and a voltage amplitude of the power grid; and
the third control signal includes a voltage of the energy storage system.

28. The power generation unit according to claim 23, wherein one of the following is true:
said energy capturing device is a photovoltaic array, and said charging controller is a direct current to direct current converter; or
said energy capturing device is a wind power generator, and said charging controller is an alternating current to direct current converter.

29. The power generation unit according to claim 23, wherein said power generation unit comprises a plurality of power generation unit branches; and each of said power generation unit branches is composed of said energy capturing device, said charging controller, said energy storage module, said power generation unit driver, said electric motor, and said synchronous generator.

30. The power generation unit according to claim 23, wherein:
said power generation unit comprises a plurality of energy input branches, wherein each of the energy input branches is composed of a switch, said energy capturing device and said charging controller, with said switch being arranged at a second side of said charging controller; and
said each energy input branch is connected to a first side of said power generation unit driver and said energy storage module via said switch.

31. The power generation unit according to claim 23, wherein
said power generation unit comprises a plurality of driving branches, wherein each of said driving branches comprises a switch, said energy capturing device, said charging controller, said energy storage module and said power generation unit driver, with said switch being arranged at a second side of said power generation unit driver; and
each said driving branch is connected to said electric motor via said switch.

32. The power generation unit according to claim 23, wherein said power generation unit comprises:
a plurality of energy input branches each composed of a first switch, said energy capturing device and said charging controller, with said first switch being arranged at a second side of said charging controller;
a plurality of energy output branches each composed of a second switch, said power generation unit driver, said electric motor and said synchronous generator, with said second switch being arranged at a first side of said power generation unit driver; and
wherein each said energy input branch is connected to said energy storage module via said first switch, and each said energy output branch is connected to said energy storage module via said second switch.

33. The power generation unit according to claim 23, wherein one of the following is true:
said electric motor is an alternating current motor and said second converter is a direct current to alternating current inverter; or
said electric motor is a direct current motor and said second converter is a direct current to direct current converter.

34. An energy output equipment in a power grid, comprising:
a power generation unit driver according to claim 18 and configure for transforming the first voltage into a second voltage according to a first control signal input by the electric motor and a second control signal input by the power grid, so as to drive the electric motor;
wherein said electric motor is connected for driving a synchronous generator to run under the effect of said second voltage; and
said synchronous generator is connected to a point of common coupling of the power grid for outputting the electric power generated thereby to the power grid.
